(19) United States
(12) Patent Application Publication
(10) Pub. No.: US 2012/0140088 A1
(43) Pub. Date: Jun. 7, 2012

(54) Photographic Light Output Power Control System and Method

(75) Inventor: James E. Clark, South Burlington, VT (US)

(73) Assignee: LAB PARTNERS ASSOCIATES, INC., South Burlington, VT (US)

(21) Appl. No.: 13/201,185

(22) PCT Filed: Feb. 12, 2010
(86) PCT No.: PCT/US10/24195

§ 371 Date: Dec. 15, 2011

Related U.S. Application Data
(60) Provisional application No. 61/152,245, filed on Feb. 12, 2009.

(51) Int. Cl. H04N 5/232; H04N 5/235

(52) U.S. Cl. 348/211.2; 348/229.1; 348/E05.037; 348/E05.042

(57) ABSTRACT

Retasking of one or more photographic exposure controls of a camera to give direct manual control of a power output level of a lighting device by mapping a dynamic range of a photographic exposure compensation control of the camera to a dynamic range of a power output level of the lighting device. In another example, mapping is used in automatic tracking of changes in ISO and/or aperture of a camera to a power output level of a lighting device. In one example, automatic tracking of power control can be provided to lighting devices (such as studio strobes) that do not usually have access to automated power control from a camera.

### RELATED APPLICATION DATA

This application claims the benefit of priority of U.S. Provisional Patent Application Ser. No. 61/152,245, filed Feb. 12, 2009, and titled “Photographic Light Output Power Control System and Method”, which is incorporated by reference herein in its entirety.

### FIELD OF THE INVENTION

The present invention generally relates to the field of control of photographic lighting. In particular, the present invention is directed to a photographic light output power control system and method.

### BACKGROUND

Photographic lighting devices typically come in a variety of sizes and capabilities for different functions, from those for the amateur hobbiest to the full-time professional applications. Two popular categories of lighting devices include speedlights and studio strobes. Speedlights are usually smaller in size and power output than studio strobes. However, modern speedlights often are configured with, and/or utilize, automated capabilities such as photographic exposure compensation and TTL, which uses information from an attached camera through the image acquisition lens to automate exposure settings and power output based on meter readings of a preflash. Studio strobes typically do not have automated power settings that utilize automatic feedback mechanisms to set the power output. Particularly, current studio strobes are believed to not have TTL or other automated modes. Typical studio strobes and other capacitor limited lighting devices regulate power output of light emission by the amount of energy stored in one or more capacitors that store the energy until the light is triggered. Changing the energy stored to a higher or lower amount in order to change the light emission power output can take significant time.

### SUMMARY OF THE DISCLOSURE

In one implementation, a method of controlling a power output level of a photographic lighting device with a photographic exposure compensation control of a camera, the photographic lighting device being set to a first power output level and the photographic exposure compensation control being set to a first compensation value is provided. The method includes changing the photographic exposure compensation control to a second compensation value; using the second compensation value and a mapping of the dynamic range of a photographic exposure compensation control of a camera to the dynamic range of a power output level of a photographic lighting device, determining a second power output level that corresponds to the second compensation value; and automatically setting the photographic lighting device to the second power output level.

In another implementation, a method of controlling a power output level of a photographic lighting device is provided. The method includes generating a mapping of the dynamic range of a photographic exposure compensation control of a camera to the dynamic range of a power output level of a photographic lighting device; providing, after said mapping, the lighting device with the power output level set to a first power output level; providing, after said mapping, the camera with the photographic exposure compensation control set to a first compensation value; changing the photographic exposure compensation control to a second compensation value; using the mapping and the second compensation value, determining a second power output level that corresponds to the second compensation value; and setting the photographic lighting device to the second power output level.

In yet another implementation, a wireless photographic communication device for synchronizing a camera to a photographic lighting device is provided. The wireless photographic communication device includes a connection to an external connector of the camera that provides a signal including a value for a current photographic exposure compensation value of the camera; a memory including information having a mapping of the dynamic range of a photographic exposure compensation control of the camera to a dynamic range of a power output level of the photographic lighting device; a transmitter; and a processor for correlating the current photographic exposure compensation value to a power output level of the lighting device and using the transmitter to wirelessly communicate the power output level of the lighting device to the lighting device.

In still another implementation, a system of controlling a power output level of a photographic lighting device with a photographic exposure compensation control of a camera, the photographic lighting device being set to a first power output level and the photographic exposure compensation control being set to a first compensation value is provided. The system includes a means for changing the photographic exposure compensation control to a second compensation value; a means for using the second compensation value and a mapping of the dynamic range of a photographic exposure compensation control of a camera to the dynamic range of a power output level of a photographic lighting device, determining a second power output level that corresponds to the second compensation value; and a means for automatically setting the photographic lighting device to the second power output level.

In still yet another implementation, a method of controlling a power output level of a photographic lighting device with a photographic exposure compensation control of a camera set to a first ISO setting and a first aperture setting is provided. The method includes determining a desired power output level for the photographic lighting device for the first ISO setting and the first aperture setting; setting the photographic lighting device to the desired power output level; adjusting the ISO setting and/or the aperture setting of the camera; automatically determining an updated power output level; and automatically setting the photographic lighting device to the updated power output level.

In a further implementation, a method of wirelessly controlling a power level of a non-TTL capable photographic flash device having the ability to adjust the illumination output level prior to triggering a flash burst by a camera is provided. The method includes detecting an exposure compensation signal generated by manual input by a user actuating a control of a camera body operating in a mode that does not automatically adjust the aperture utilized for image acquisition based on the exposure compensation inputs of the camera body; wirelessly communicating an instruction based on the exposure compensation signal to a remote non-TTL flash device; automatically adjusting the amount of stored energy for flash illumination in the non-TTL flash device based on the instruction prior to initiation of a flash emission by the non-TTL flash device.

In still a further implementation, a method of wirelessly controlling a power level of a non-TTL capable photographic flash device having the ability to adjust the illumination output level prior to triggering a flash burst by a camera is provided. The method includes detecting an exposure compensation signal generated by manual input by a user actuating a control of a camera body operating in a mode that does not automatically adjust the aperture utilized for image acquisition based on the exposure compensation inputs of the camera body; wirelessly triggering the emission of a remote non-TTL flash device to correspond with a first image acquisition by the camera body; detecting an aperture setting and a gain setting of the camera body, wherein the aperture and/or gain setting is different from the corresponding setting of the camera body used for the first image acquisition; wirelessly adjusting the power output capability of the non-TTL flash device prior to flash light emission of the non-TTL flash device based on a calculated power adjustment, the power adjustment calculated from the exposure compensation signal, the aperture setting, and the gain setting; and wirelessly triggering the emission of the remote non-TTL flash device to correspond with a second image acquisition by the camera body.

### DETAILED DESCRIPTION

A system and method is provided for direct manual power output control of lighting devices by repurposing photographic exposure compensation controls of a camera body from the original purpose for the controls of providing an offset value to the camera body's automated exposure power value.

In one embodiment, one or more photographic exposure controls of a camera are retasked to give direct manual control of the power output level of a lighting device by mapping the dynamic range of a photographic exposure compensation control of the camera to a dynamic range of a power output level of the lighting device. In another embodiment, the mapping allows for automatically tracking changes in ISO and/or aperture of the camera to a power output level of a lighting device. In one example, automatic tracking of power control can be provided to lighting devices (such as studio strobes) that do not usually have access to automated power control from a camera.

There are two different types of exposure compensation settings associated with a camera: overall camera exposure compensation and flash exposure compensation. Camera exposure compensation is typically referred to as simply “exposure compensation.” Throughout this disclosure the term exposure compensation refers to total camera exposure compensation. For shorthand the term exposure compensation will be referred to as EC and the term flash exposure compensation will be referred to as FC. The term “EC/FC” will refer to one or more of exposure compensation, flash exposure compensation, and any combinations thereof. Additionally, the terms “photographic exposure compensation” and “EC/FC” are used herein interchangeably.

An exposure compensation setting of a camera (e.g., a digital SLR camera) is a setting that allows a user to modify the standard, automatically calculated exposure of the camera. When the camera is operating in an automated mode (e.g., a fully automated mode where Aperture, Shutter Speed, and possibly ISO are set by the camera based on one or more meter readings; an aperture priority mode where the shutter speed, and possibly the ISO, is set by the camera based on one or more meter readings; a shutter speed priority mode where the aperture, and possibly the ISO, is set by the camera based on one or more meter readings), the EC setting on the camera automatically modifies the standard automated setting. In one example, the EC setting biases the camera's meter so that automated settings are different than they would be without the EC setting. EC values may be stated in terms of exposure value (“EV”). One EV is equal to one exposure stop. When a camera is set in a fully manual mode where the user sets both shutter speed and aperture settings, EC values do not impact camera exposure. Note that some Nikon cameras will bias the meter readings of the camera by the EC value when the camera is in a manual mode. EC value settings on a camera are a positive or negative offset to an otherwise determined exposure setting.

As used herein the term “ISO” refers to the photographic usage of the term that historically relates to film sensitivity. However, as used herein the term also refers to the sensitivity or gain of a digital camera imaging sensor.

A flash exposure compensation setting of a camera is utilized to provide a positive or negative offset to an automatically determined flash output power. An FC setting of a camera will modify the flash output power of a flash using an automated mode (i.e., one where the user is not required to set the output power of the flash device). Typical automated modes are TTL and AUTO modes. A manual lighting mode is typically referred to as MANUAL. When a lighting device is in a MANUAL mode a camera's flash exposure compensation setting does not modify the manual settings of the lighting device.

Examples of TTL and AUTO capable lighting devices include, hot shoe mountable flash lights and speedlights. Some lighting devices, such as studio strobes, do not have TTL and/or AUTO modes. The power settings for some typical studio strobes are a direct setting using, for example, a dial on the outside of the flashpack, a digital input to the power control, an analog input to the power control, etc.

In one embodiment, a system and method of direct power setting of a lighting device is provided using an EC/FC setting of a camera body. Examples of such a system and method retask the EC/FC setting from the designed operation of offsetting an automatically determined exposure setting to provide a camera user with a direct manual power control on the camera for directly setting the power output of a lighting device.

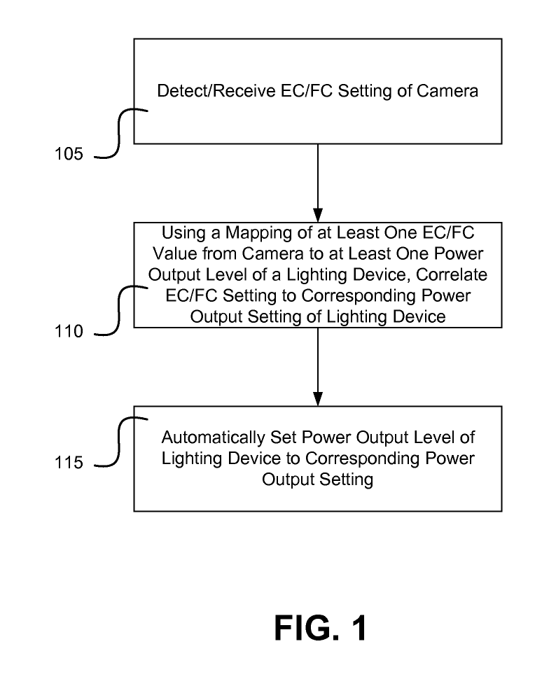

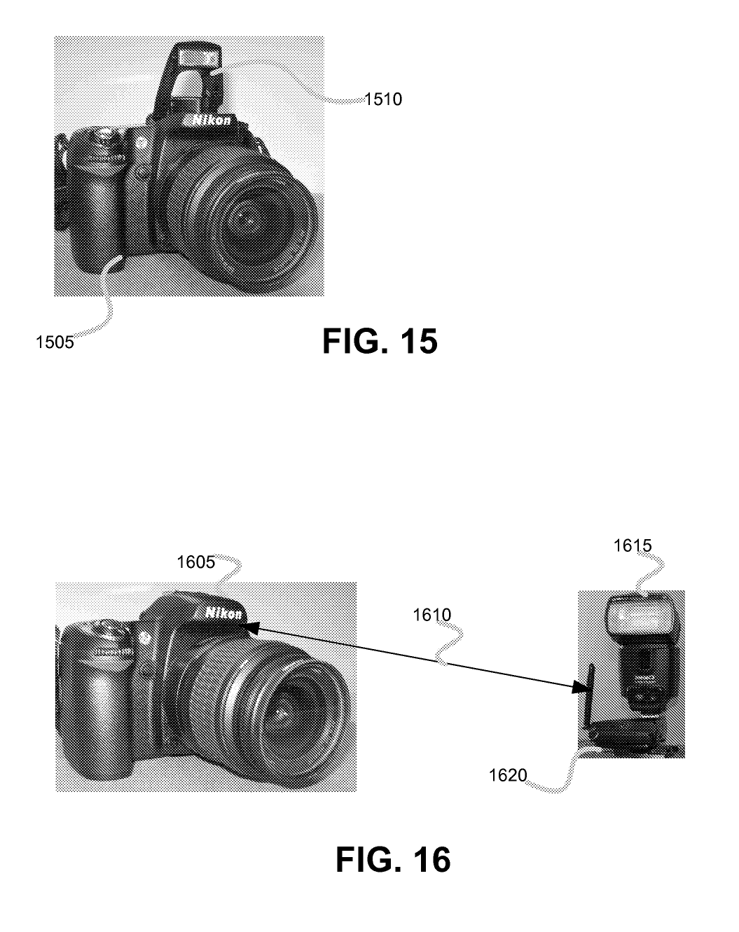

FIG. 1 illustrates one exemplary implementation of a method of direct power control of a lighting device. At step 105, a current EC/FC setting of a camera is detected. As used herein the term “detect” is intended to include receive (e.g., if a circuit element receives a data value representative of an EC value or an FC value, the value is detected). In one example, the EC/FC setting of a camera is determined via internal connections in the camera. In another example, the EC/FC setting of a camera is determined via an external connector of the camera (e.g., a hot shoe connector). Examples of internal and external determinations are discussed further below (e.g., with respect to FIGS. 15 to 18).

At step 110 a direct mapping of at least one EC/FC setting of a camera to at least one power output level of a lighting device is utilized to correlate the current EC/FC setting of the camera to a corresponding power output level of the lighting device. Example mapping techniques are discussed further below.

At step 115 the corresponding power output level of the lighting device is automatically set on the lighting device. In one example, the automatic setting of the power level occurs via an connection between circuitry of the camera and an internal lighting device. In another example, the automatic setting of the power level occurs via an external wired connection between circuitry of the camera configured to make the automatic setting and an external lighting device. In yet another example, a wireless communication device (internal and/or external to the camera) wirelessly communicates information instructing a wireless communication device connected to a remote lighting device to automatically set the power level of the lighting device. Example connections to the lighting device include, but are not limited to, a hot shoe connector, a serial power control connector, a proprietary power control connector, and any combinations thereof.

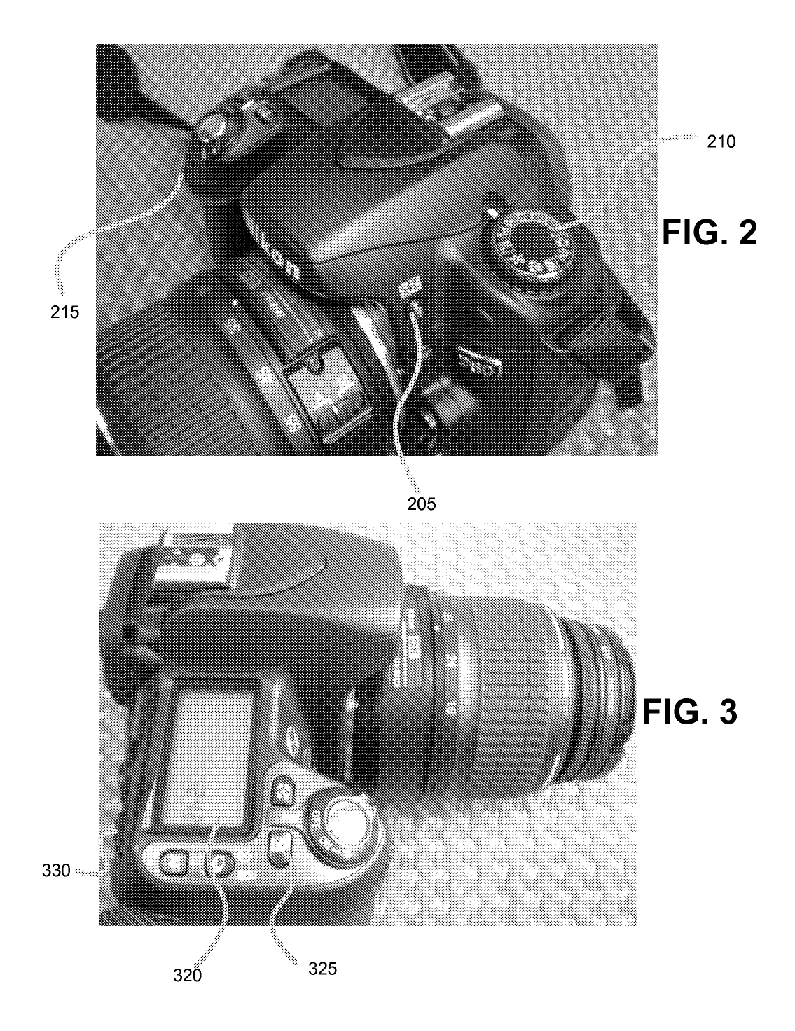

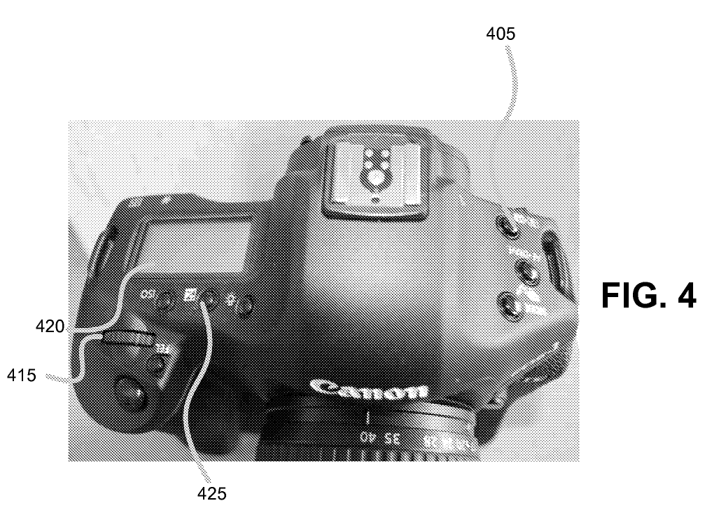

FIG. 2 illustrates a first view of an example of a camera having a flash compensation button 205, a camera mode dial 210, and a first toggle dial 215. FIG. 3 illustrates another view of the example camera of FIG. 2. FIG. 3 shows an output screen 320, an exposure compensation button 325, and a second toggle dial 330. Camera mode dial 210 may be used to set the camera operating mode (e.g., aperture priority, shutter priority, program [automates both shutter and aperture], and manual). By pressing flash compensation button 205 and turning first toggle dial 215, a user can modify an FC setting of the camera. The current FC setting of the camera may be viewed in output screen 320. By pressing exposure compensation button 325 and turning second toggle dial 330, a user may modify an EC setting of the camera. The current EC setting of the camera may be viewed in output screen 320. FIG. 4 illustrates yet another example of a camera having a flash compensation button 405, a toggle dial 415, an output screen 420, and an exposure compensation button 425. By pressing flash compensation button 405 and turning toggle dial 415, a user can modify an FC setting of the camera. The current FC setting of the camera may be viewed in output screen 420. By pressing exposure compensation button 425 and turning toggle dial 415, a user may modify an EC setting of the camera. The current EC setting of the camera may be viewed in output screen 420. Other user input mechanisms and/or output mechanisms may also be employed in a camera for inputting an EC/FC setting and/or determining a current EC/FC setting of a camera.

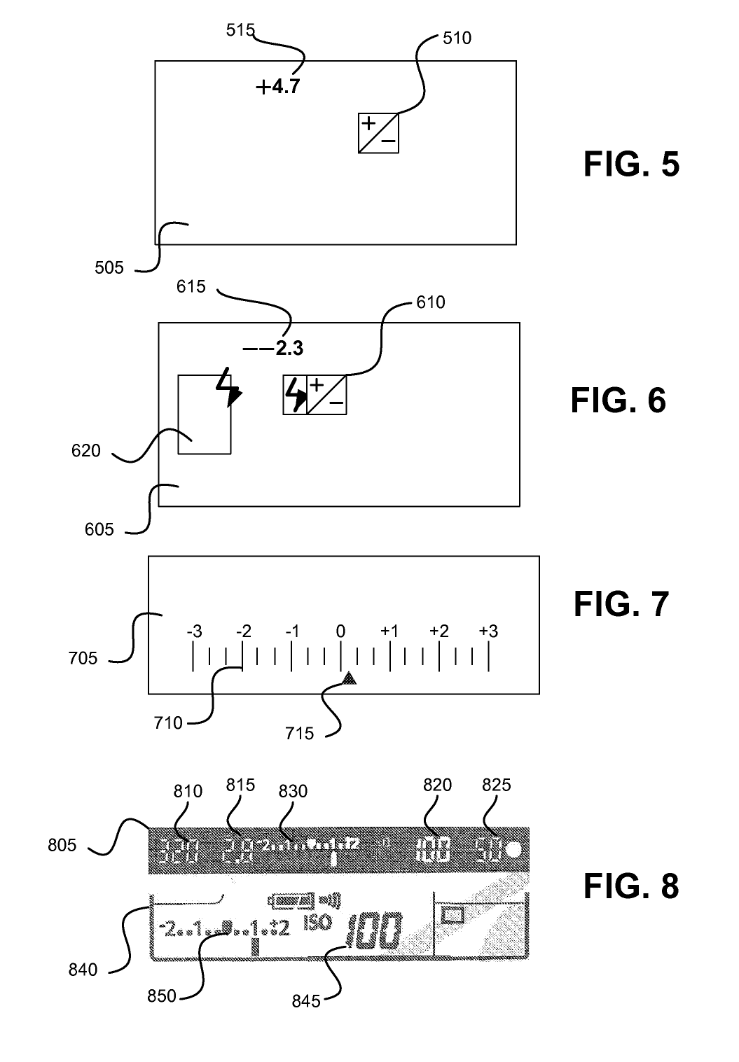

FIG. 5 illustrates one example of an output screen 505 showing an exposure compensation symbol 510 (indicating that the current view is of the EC setting) and a current exposure compensation value 515 (shown as +4.7 EV). FIG. 6 illustrates another example of an output screen 605 showing a flash compensation symbol 610 (indicating that the current view is of the FC setting) and a current FC value 615 (shown as −2.3 EV). FIG. 6 also shows a flash mode status indicator 620. FIG. 7 illustrates another example of an output screen 705 having indicators 710 of the scale of EC/FC settings from −3 EV to +3 EV in ⅓ stop values. An arrow indicator 715 indicates the current EC/FC value setting of the camera. FIG. 8 illustrates a first output screen 805 (e.g., an output screen of a camera viewfinder) having an indicator 810 of the camera shutter speed setting, an indicator 815 of the aperture setting, an indicator 820 of the ISO setting, an indicator 825 of remaining exposures, and an indictor 830 of an EC/FC value setting scale ranging from −2 EV to +2 EV in ⅓ stop increments (the current EC/FC value indicated by a white bar under the +1 setting). FIG. 8 also includes a second output screen 840 having an indicator 845 of ISO setting and an indicator 850 of an EC/FC value setting scale ranging from −2 EV to +2 EV in ⅓ stop increments (the current EC/FC value indicated by a black bar under the +1 setting).

An EC setting range may vary from one camera model to another. Any range may be utilized. In one example, a range of EC settings of a camera is −5 EV to +5 EV. In another example, a range of EC settings of a camera is −3 EV to +3 EV. In yet another example, a range of EC settings of a camera is −3 EV to +1 EV. In still another example, a range of EC settings of a camera is −2 EV to +2 EV. The increments of the range may also vary. In one example, the increments of an EC range are in ½ f-stops. In another example, the increments of an EC range are in ⅓ f-stops. In yet another example, a camera may allow a user to define the increment for a given operation of a camera (e.g., a choice between ½ f-stop and ⅓ f-stop increments).

An FC setting range may vary from one camera model to another. Any range may be utilized. In one example, a range of FC settings of a camera is −5 EV to +5 EV. In another example, a range of FC settings of a camera is −3 EV to +3 EV. In yet another example, a range of FC settings of a camera is −3 EV to +1 EV. In still another example, a range of FC settings of a camera is −2 EV to +2 EV. The increments of the range may also vary. In one example, the increments of an FC range are in ½ f-stops. In another example, the increments of an FC range are in ⅓ f-stops. In yet another example, a camera may allow a user to define the increment for a given operation of a camera (e.g., a choice between ½ f-stop and ⅓ f-stop increments).

In conventional operation, the plus/minus character of the compensation relates to an offset from an otherwise automatically determined exposure value in the case of EC and an automatically detected/calculated light output value in the case of FC. A system and/or method of direct power control according the current disclosure allows a user to take advantage of a preexisting camera control that was designed for something other than direct light power control and utilize it for direct light power control.

A power output range may vary from one lighting device to another. In one example, a power output range may be values ranging from the maximum power output of the lighting device to a minimum power output setting of the lighting device. In one example, a power output range of a lighting device is 0 to −8, with the 0 being the maximum power setting and the −8 being the minimum power setting. In another example, a power output range of a lighting device is 0 to −10, with the 0 being the maximum power setting and the −10 being the minimum power setting. In another example, a power output range of a lighting device is 0.5 to 6.5 in 1/10^{th} f-stop increments. The increments may be in any values. In one example, increments of a power range may be expressed in f-stops (and/or partial f-stops). In another example, increments of a power range may be expressed in arbitrary numbering scale. In yet another example, increments of a power range may be expressed in watts * seconds.

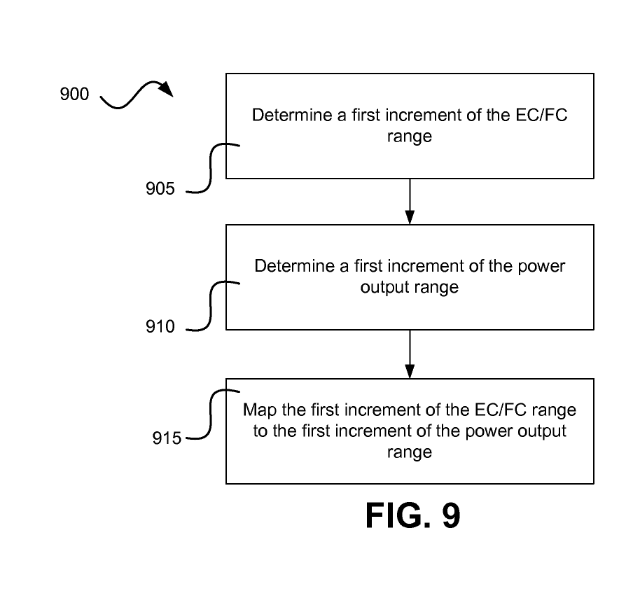

FIG. 9 illustrates one example of a method 900 for mapping an EC/FC setting range of a camera control to a power output range of a lighting device. At step 905, a first increment of an EC/FC range of a camera that is desired to map is determined. At step 910, a first increment of a power range of a lighting device that is desired to map is determined. At step 915, the first increment of the EC/FC range is mapped to the first increment of the power range. Steps 905 to 915 may be repeated for other increments of the EC/FC range and the power output range. Mappings may be stored in a memory (e.g., for use in correlating a current EC/FC setting from the camera to a power output setting of the lighting device).

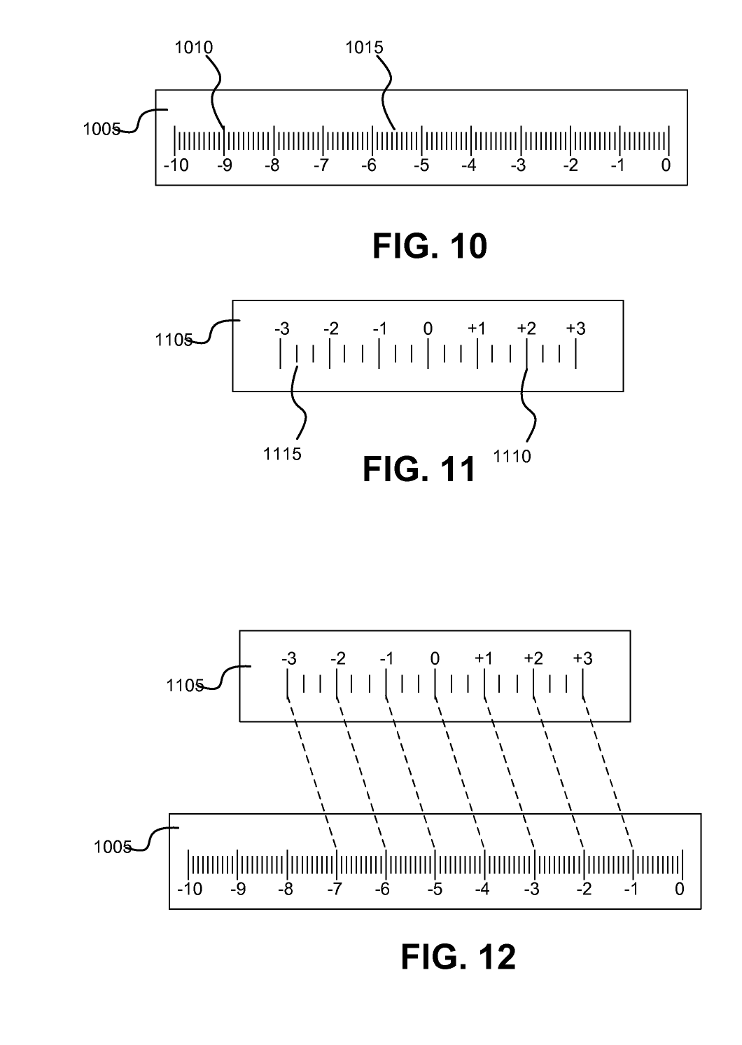

FIG. 10 illustrates an example power output range 1005 of an example lighting device has ten major increments 1010 each divided into 1/10^{th} f-stop minor increments 1015. In this example, the zero major increment is the maximum power setting for the lighting device. FIG. 11 illustrates one example EC/FC settings range 1105 for an example camera control having six major increments 1110 ranging from a value of −3 to a value of +3 and divided into ⅓ f-stop minor increments 1115.

In one exemplary implementation, a single increment of an EC/FC range (e.g., a center increment, a minimum increment, and/or a maximum increment) is mapped to a single increment (e.g., a center increment, a minimum increment, and/or a maximum increment) of a power range of a lighting device. For example (using FIGS. 10 and 11 for illustration purposes), the maximum power output setting of zero in range 1005 is mapped to the +3 EC/FC setting of range 1105. In one exemplary utilization of the mapping, a user initiates direct power control and the current EC/FC setting value of the camera is determined (for example, the current setting is −1). The current setting of −1 is correlated to the mapping of the power output range to the EC/FC range. In this exemplary implementation the only direct mapping is zero on the power output increment to the +3 on the EC/FC range. A variety of correlation techniques may be employed. In one example, the current EC/FC value of −1 is mapped to −4 on the power output level (e.g., 4 f-stops difference). Other correlation techniques will be apparent from discussions herein.

In another exemplary implementation, a full mapping of an EC/FC settings range to a range of power output of a lighting device is performed during calibration. FIG. 12 illustrates one example of mapping power output range 1005 to EC/FC range 1105. In this example, full f-stop increments of the EC/FC settings range 1105 are mapped to full f-stop increments in the middle of the power output range 1005. This gives the user of the camera power control over a good portion of the middle power output levels of the lighting device. However, it does not allow a direct setting of the power output to the maximum output or to very low power output.

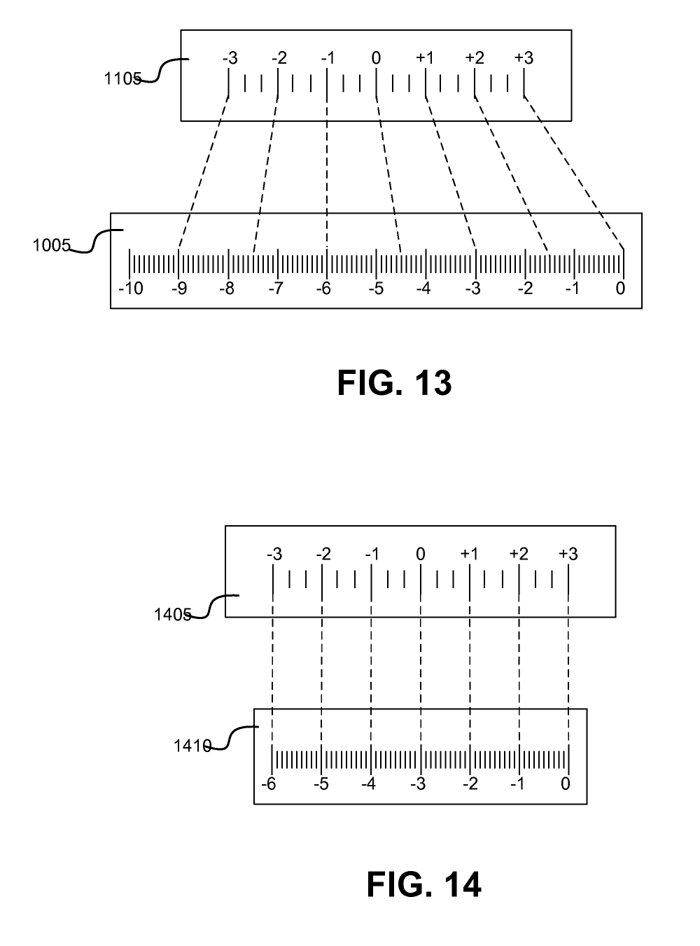

FIG. 13 illustrates another example of mapping power output range 1005 to EC/FC range 1105. In this example, each full f-stop increment of the EC/FC range 1105 is mapped to a 1.5 f-stop increment of the power output range 1005. For example, +3 on range 1105 is mapped to maximum power output level zero of range 1005. The +2 setting on range 1105 is mapped to increment −1.5 on range 1005, +1 on range 1105 is mapped to increment −3 on range 1005, etc. This mapping gives the user of the camera control almost full direct control of the power output level of the lighting device.

FIG. 14 illustrates one example of direct mapping of an EC/FC settings range 1405 of a camera control to a power output range 1410 of a lighting device. In this example, each range includes six major increments that map directly to each other giving full direct power control of the lighting device from the camera control.

In one example of mapping and correlation examples where minor increments do not match from one range to another (e.g., ⅓ f-stop increments to 1/10^{th} f-stop increments), a closest match procedure can be used. For example, a ⅔ f-stop increment can map to a 7/10^{th} f-stop increment. In another example of mapping, a zero increment on an EC/FC range may be mapped to a middle of a power output range of a lighting device.

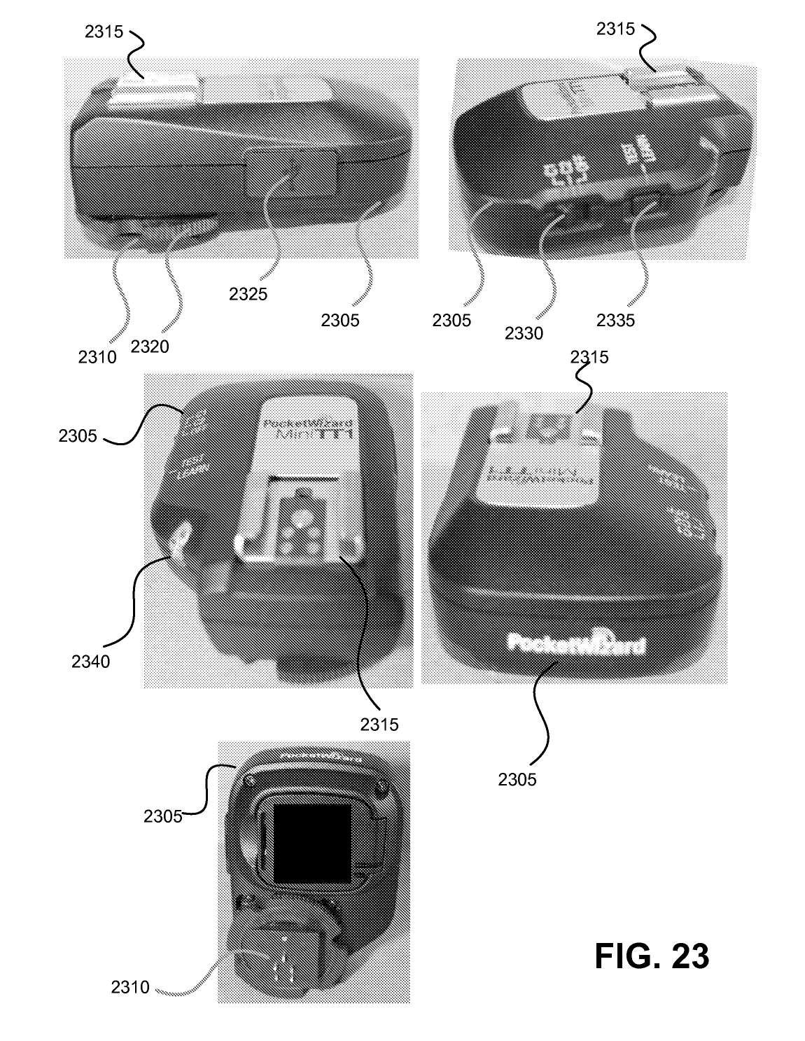

It is contemplated that the visual mappings shown in the figures above can readily be converted to mathematical representations for implementation in a machine, such as a direct power control device (e.g., as shown in FIG. 23). In one example, information related to a mapping for execution in a machine may be in the form of machine executable instructions stored in a machine readable storage medium. In one such example, a crossover table may be utilized to track mappings of dynamic ranges. In another such example, mapping of dynamic ranges may be represented by a formula (e.g., as shown by example below in discussion of automatic tracking of power control).

FIG. 15 illustrates one example of a camera 1505 having a built-in flash device 1510. In one exemplary implementation, camera 1505 may include appropriate circuitry and/or instructions capable of execution by one or more circuit elements of camera 1505 that monitor (e.g., receive) a current EC/FC setting value of camera 1505. Camera 1505 includes a memory for storing a direct mapping of EC/FC setting values to the power output range of the built-in flash device 1510. Appropriate circuitry and/or instructions capable of execution within camera 1505 correlates the current EC/FC setting value to a corresponding power output setting of flash device 1510 without modification of (or influence from) another automatically generated power setting (such as via a TTL metering process). The circuitry and/or instructions of camera 1505 may also include instructions and configuration for implementing any one or more of other implementations and/or embodiments as disclosed herein for directly manually controlling and automatically tracking power output level of flash device 1510.

FIG. 16 illustrates one example of a camera 1605 having a built-in radio frequency wireless communication functionality (not shown). In one exemplary implementation, the wireless communication functionality may be utilized to wirelessly communicate with one or more remote devices via a radio frequency transmission, such as transmission 1610. A remote lighting device 1615 is shown. Remote lighting device 1615 is an example of a hot shoe mountable speedlight flash device. The built-in wireless communication functionality of camera 1605 may be utilized to wirelessly communicate power control information according to the disclosure herein with remote lighting device 1615 and/or one or more other types of lighting devices (e.g., one or more other hot shoe mountable lights, one or more studio strobe lighting devices). Remote lighting device 1615 is shown connected to an external wireless device 1620. It is contemplated that any one or more remote devices may include an internal wireless functionality. In one exemplary direct power control utilization, camera 1605 includes appropriate circuitry and/or instructions capable of execution by one or more circuit elements of camera 1605 that monitor (e.g., receive) a current EC/FC setting value of camera 1605. In one example, the current EC/FC setting value of camera 1605 is correlated with a mapping stored in a memory of camera 1605, the corresponding power output setting information is wirelessly communicated to remote flash device 1615, and the corresponding power output setting is set for remote flash device 1615 using circuitry and/or instructions included in wireless device 1620. In another example, information representing the current EC/FC setting value is wirelessly communicated to remote flash device 1615 via wireless device 1620 and the corresponding power output setting is determined using mapping information stored in a memory of wireless device 1620. Wireless device 1620 sets the corresponding power output level on remote flash device 1615. The circuitry and/or instructions of camera 1605 may also include instructions and configuration for implementing any one or more of other implementations and/or embodiments as disclosed herein for directly manually controlling and automatically tracking (e.g., via ISO and aperture values of camera 1605) power output level of flash device 1615.

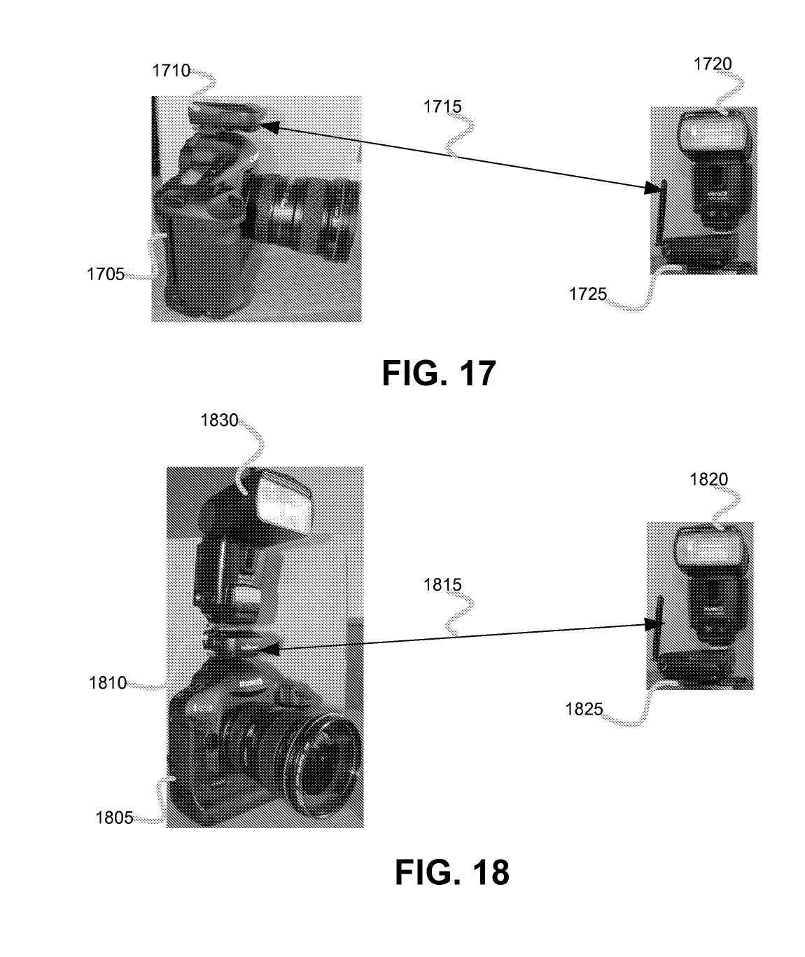

FIG. 17 illustrates one example of a camera 1705 having an external wireless device 1710 connected via a hot shoe connector of camera 1705. External wireless devices are known. In one aspect, an external wireless device may be configured to communicate data (e.g., camera and/or flash data) to and/or from a camera via one or more of the contacts of a hot shoe connector. Examples of external wireless devices configured for connection to a camera hot shoe and methodologies for communicating via a hot shoe connector are discussed in further detail in copending U.S. patent application Ser. No. 12/129,402 filed on May 29, 2008, the disclosure of which is incorporated herein by reference in its entirety. For example, an external wireless communication device connected via a hot shoe connector to a camera may communicate a signal via the hot shoe connector to the camera that allows the wireless communication device to mimic the existence of a TTL-capable flash connected to the hot shoe connector. This tricking allows the camera to continue to send serial data via one of the connector pins of the hot shoe connector that otherwise may not be communicated to a non-TTL capable auxiliary device in the hot shoe connector. In one example, such serial data may include a value of a photographic exposure compensation control of the camera.

Camera 1705 may utilize wireless device 1710 to wireless communicate via a wireless transmission, such as transmission 1715, with one or more remote devices. A remote lighting device 1720 is shown connected via a hot shoe connector to a wireless device 1725. As discussed above, a camera may communicate with one or more remote lighting devices for synchronizing the one or more lighting devices to image acquisition and/or for communicating power control information according to the disclosure herein with the one or more remote lighting devices. The one or more remote lighting devices may each include an external wireless functionality, an internal wireless functionality, or any combination thereof. In one exemplary direct power control implementation, camera 1705 (and/or wireless device 1710) may include appropriate circuitry (and/or instructions capable of execution by one or more circuit elements) that monitor (e.g., receive) a current EC/FC setting value of camera 1705. In one example, the current EC/FC setting value is detected via the hot shoe connector by wireless device 1710. The current EC/FC setting value is correlated to a corresponding power output setting of one or more remote lighting devices 1720. In one example, the current EC/FC setting value of camera 1705 is correlated with a mapping stored in a memory of camera 1705, the corresponding power output setting information is communicated via the hot shoe to wireless device 1710, wirelessly communicated to remote flash device 1720, and the corresponding power output setting is set for remote flash device 1720 using circuitry and/or instructions included in wireless device 1725. In another example, the current EC/FC setting value of camera 1705 is correlated with a mapping stored in a memory of wireless device 1710, the corresponding power output setting information is wirelessly communicated to remote flash device 1720, and the corresponding power output setting is set for remote flash device 1720 using circuitry and/or instructions included in wireless device 1725. In yet another example, information representing the current EC/FC setting value is wirelessly communicated to wireless device 1725 via wireless device 1710, the corresponding power output setting is determined using mapping information stored in a memory of wireless device 1725. Wireless device 1725 sets the corresponding power output level on remote flash device 1720. The circuitry and/or instructions of camera 1705 and/or wireless communication device 1710 may also include instructions and configuration for implementing any one or more of other implementations and/or embodiments as disclosed herein for directly manually controlling and automatically tracking (e.g., via ISO and aperture values of camera 1705) power output level of flash device 1715.

FIG. 18 illustrates one example of a camera 1805 having an external wireless device 1810 connected via a hot shoe connector. Camera 1805 may utilize wireless device 1810 to wirelessly communicate (e.g., via a transmission 1815) to one or more remote lighting devices 1820 having a wireless functionality 1825 (e.g., an internal wireless functionality and/or external wireless functionality, as shown). A hot shoe mountable flash device 1830 is connected to a second hot shoe connector of wireless device 1810. Exemplary direct power control implementations and auto tracking implementations for the system of FIG. 18 are similar to implementations of FIG. 18, except power control information may also (or alternatively) be communicated to lighting device 1830.

In another embodiment, a method and system of automatic power tracking control is provided. In one example, a calibration is made between a first EC/FC setting increment on a camera control and a desired power output of a lighting device with the camera at a specific ISO. In another example, a calibration is made between a first EC/FC setting increment on a camera control and a desired power output of a lighting device with the camera at a specific aperture. In yet another example, a calibration is made between a first EC/FC setting increment on a camera control and a desired power output of a lighting device with the camera at a specific ISO and aperture.

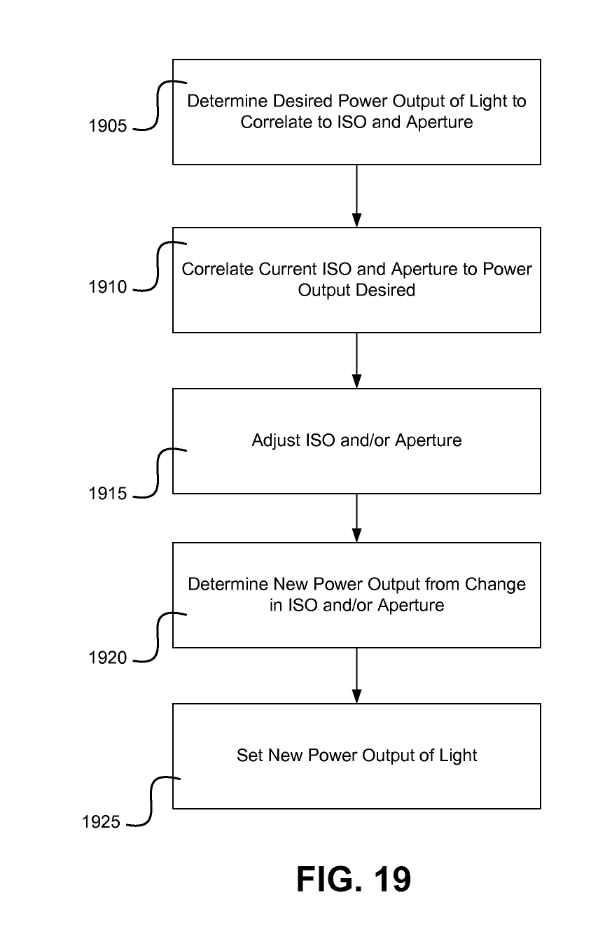

FIG. 19 illustrates one exemplary implementation of an automatic power tracking control method. At step 1905, a desired power output of light from a lighting device associated with a camera is determined at a specific ISO and aperture. In one example, a manual mapping of the power output range of the lighting device to the EC/FC range of the camera control is performed (e.g., before step 1905). One example way to determine the desired power output level of the lighting device includes taking a picture with the camera at a first ISO, first aperture, first EC/FC setting, and first power output level. If the image is not satisfactorily illuminated the power output level of the lighting device can be modified and another picture can be taken to assess the light. In one example, the power of the lighting device can be modified manually at the lighting device (e.g., where a mapping of the EC/FC range to the power output range has not occurred). In another example, the power of the lighting device can be directly modified by a change to the EC/FC setting of the camera control (e.g., where a mapping of the EC/FC range to the power output range has occurred). The picture assessment can continue until a satisfactory power output setting is achieved. Other example ways to determine the desired power output level of the lighting device at the first ISO and first aperture setting include, but are not limited to, using a light meter (e.g., a remote light meter, a light meter on camera), using empirical understanding of the lighting needs of the scene (e.g., obtained from experience lighting scenes), and any combinations thereof.

When the power output setting of the lighting device is determined to be appropriate, the method proceeds to step 1910. At step 1910, the ISO and aperture utilized to determine the appropriate power output level is mapped to the ISO and aperture (e.g., in a memory).

At step 1915, the user of the camera modifies the ISO setting of the camera and/or the aperture setting of the camera (e.g., during subsequent image acquisitions).

At step 1920, using the mappings of the starting ISO and aperture to the starting power level, a new power output level of the lighting device is determined for the new aperture and/or ISO setting. Various equations for associating changes in an aperture and/or ISO value with an f-stop change are known.

In one example, each ISO value for a camera is mapped to a range of 0 to 255, each aperture value for a camera is mapped to a range of 0 to 255, and each EC/FC value for a camera is mapped to a range of 0 to 255. An incremental change in a value in one of these ranges can be correlated to an f-stop change. For example, a change of an ISO value from a 1 to a 2 on the scale may correlate to a ⅛^{th} f-stop change on one camera model and a ⅙^{th} f-stop change on a different camera model. This correlation can be determined from analysis of the camera models and, for example, information communicated via the hot shoe connector of the camera that represents ISO, aperture, and/or EC/FC value. The f-stop change associated with a change in aperture, ISO, and/or EC/FC can be correlated to a change in power output level for the lighting device.

At step 1925, the new power output level of the lighting device is set automatically. In one example, a wireless communication device associated with the camera (e.g., in a hot shoe connector, internal to the camera) that had received the adjusted ISO and/or aperture values from the camera and compared them to information stored regarding starting ISO, aperture, and power output level, wirelessly communicates a new power output level to a remote lighting device (e.g., a manual power control strobe flash pack). A wireless communication device at the lighting device location (e.g., an internal wireless communication device having connections to internal power control circuitry of the flash device, an external wireless communication device connected to a power control input of the flash device) communicates the new power setting to the lighting device to set the new power output level.

It should be noted that the method of FIG. 19 allows for automatic power output tracking to aperture and ISO without the need for sensor information regarding the illumination of the scene being imaged. An initial direct power control setting may be made in the case where the EC/FC camera control is utilized to set the starting power output of the lighting device. As an aperture and/or ISO are modified, there is no need for sensor information (e.g., an optical sensor on a lighting device, lighting information derived by TTL metering. The automatic power output tracking simply requires aperture and/or ISO changes, which (for example) can be detected via the hot shoe by an external wireless device that can perform the power output tracking.

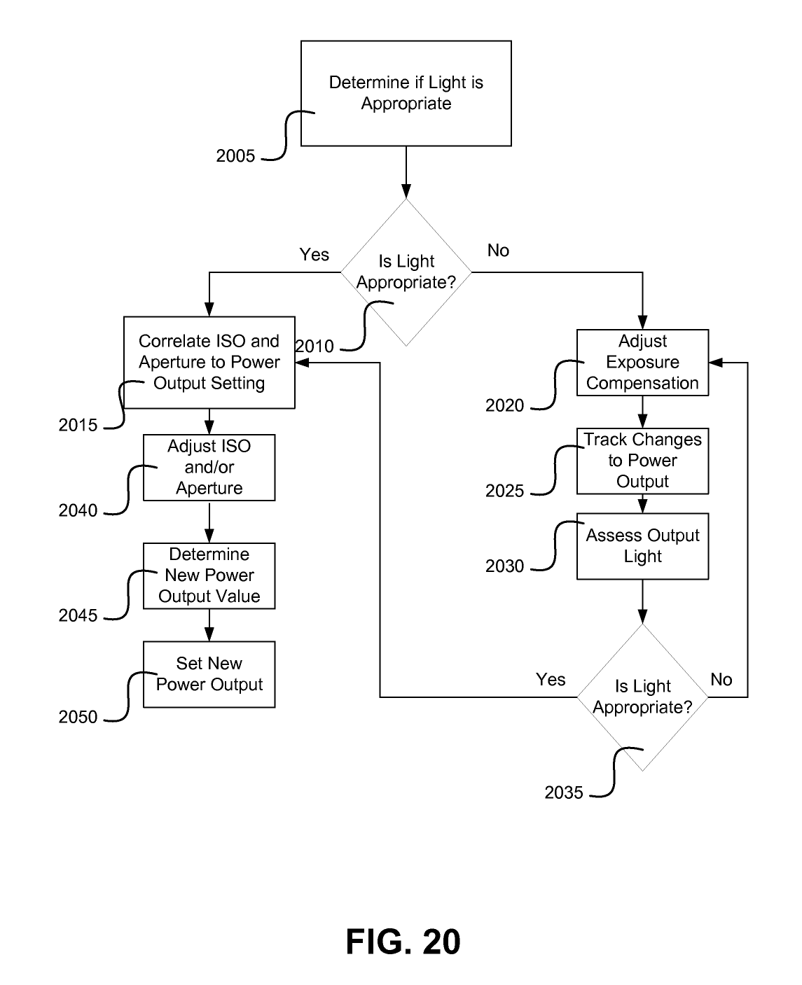

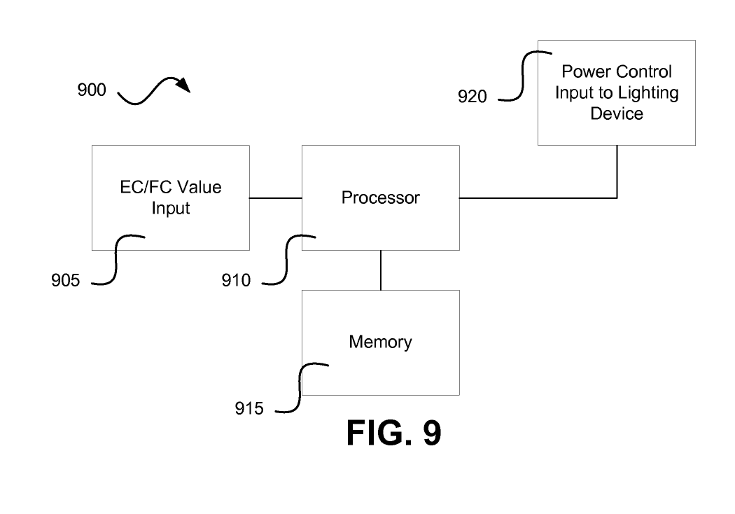

FIG. 20 illustrates yet another example of a method of automatic power output tracking utilizing direct power control for setting a desired power output level for a given ISO and aperture. At step 2005, a determination is made as to the desirability of the light output level of a lighting device associated with a camera for image acquisition. Example ways of determining the desirability of the light output include, but are not limited to, analyzing an image taken with the camera at the initial ISO and aperture setting, utilizing a metering device, general knowledge of the lighting environment of the image acquisition, review of a histogram of the exposure data associated with an image taken with the camera at the initial ISO and aperture settings, and any combinations thereof. In one example, the determination of appropriateness of light output includes using a photographic exposure compensation control of the camera to select a compensation value, determining a corresponding power output level of the lighting device using the compensation value and a mapping of the dynamic range of the photographic exposure compensation control of the camera to the dynamic range of the power output level of a photographic lighting device, and automatically setting the lighting device to the initial power output level.

If the light output is appropriate, the method proceeds to step 2015 at step 2010. If the light output is not appropriate, the method proceeds to step 2020 at step 2010. At step 2020, the photographic exposure compensation control of the camera is set to a new value. At step 2025, the change in the compensation control automatically sets the output level of the lighting device to a new value according to a mapping of the dynamic ranges of the power output and the compensation control. At step 2030, the light output is assessed again at the new directly controlled setting. In one example, the light output is assessed by taking an image and analyzing the image. Other exemplary ways of assessing the light output have been discussed above. If the light output is not desired at step 2035, the method repeats steps 2020, 2025, and 2030. If the light output is desired at step 2035, the method proceeds to step 2015.

At step 2015, the current ISO and aperture values of the camera are correlated to the current power output level of the lighting device. In one example, the correlation is direct (e.g., as in a crossover table that maps ISO, aperture, and power level values for a camera and/or lighting device. In another example, a formula is utilized to automatically determine and set the power output level of the lighting device based at least in part on the ISO, aperture, and photographic exposure compensation control value. An example of such a formula is discussed further below. In such an example, when the compensation control value is modified (e.g., at step 2020) the formula calculates and instructs appropriate circuitry to set the power output level of the lighting device. In another example, the method of FIG. 20 can be used to set the initial value of the power output level for a given ISO and aperture (e.g., in a calibration by a user of the camera).

At step 2040, the ISO and/or the aperture are adjusted to a new value (e.g., during normal camera operation and modification). At step 2045, a corresponding new power output level is determined (e.g., from a power calculation formula, from a crossover table, etc.). At step 2050, the power output of the lighting device is automatically set to the new power output value.

Various formulas may be utilized to map the dynamic range of a compensation control to a dynamic range of a power output level of a lighting device. In one implementation, an initial mapping is made between one setting on the compensation control and one setting on the power output level. This can be used to align those regions of the two ranges. A mapping constant can be determined from the two values. For example, if the compensation control value of +3 is mapped to the power output level of −5, a resulting mapping constant may be −8 (i.e., the difference in f-stop values between the two settings). If the increments between full f-stop values on the two ranges differ and/or if a scale is desired (as discussed above with respect to FIGS. 10 to 14), a scaling factor can be used. One equation for relating the scaling factor, the compensation value, and the mapping constant to the power output level includes: P=mx+b, where P is the power output value as a base 2 log value, m is the scaling factor, x is the compensation value as a base 2 log value, and b is the mapping constant.

Mapping by formula can be performed in a variety of value units. In one example, f-stop and other exposure units may be converted to hexadecimal, digital, or other values. In one such example, mapping formula constants and variable each have a value range from 1 to 255.

In another exemplary implementation, a mapping formula may be utilized for automated tracking of changes in ISO and/or aperture. In this example, a formula is adjusted using program constants that provide a zero offset representing the highest power of the light. This is achieved with an ISO constant with a value corresponding to ISO 100 for the camera (i.e., this is the value used by the camera to communicate a setting of ISO at 100. This is typically one of the lowest ISO settings for a camera and represents the least sensitivity for the sensor. An aperture constant is set with a value corresponding to f-stop 32 for the camera (i.e., this is the value used by the camera to communicate a setting of f-stop 32). F-stop 32 is a high aperture setting for many lenses and corresponds to a small aperture opening. Both of these constants offset toward a high power output requirement. The formula also takes into account photographic exposure compensation value from the camera, actual ISO value from the camera, actual aperture value from the camera, and a user settable offset. Mapping formulas can include a user settable offset to give the camera user flexibility in use of the formula. In one exemplary use of the user offset value it can be set by a dynamic mapping of a range of the compensation control of the camera to the range of the power level of the lighting device. In one such example, center points of the ranges are mapped. The formula in this example is as follows:

P=CompV+(ISOactual−ISO100constant)+(F32constant−Aactual)−Useroffset

Where P is the power output level value for the lighting device;

CompV is the photographic exposure compensation control value;

ISOactual is the actual value of the current ISO setting of the camera;

ISO100constant is the ISO constant discussed above;

F32constant is the aperture constant discussed above;

Aactual is the actual value of the current aperture setting of the camera; and

Useroffset is the value of the user settable offset.

In one example, the user can set the user offset in a utility program that connects to a device having circuitry and appropriate instructions for executing a method of automatic power level tracking as described herein (e.g., an appropriately configured camera, an appropriately configured wireless communication device, etc.). In one example, a USB connection of a wireless communication device configured to implement one or more of the aspects of a method as disclosed herein may be connected to a computing device having a utility program that allows the setting of the user settable offset, allows mapping of dynamic ranges, and/or allows setting of other parameters of the device.

Some cameras combine ISO values and FC values into one value. In one example, the combined value is sent up through the hot shoe. When using a hot shoe based wireless communication device and the ISO value and/or the FC value is required, an example of a procedure to extract the values from the camera can be followed. Examples of external wireless devices configured for connection to a camera hot shoe and methodologies for communicating via a hot shoe connector (e.g., that the wireless communication device is mimicking a flash device operating in a manual mode and/or a TTL mode) are discussed in further detail in copending U.S. patent application Ser. No. 12/129,402 filed on May 29, 2008, the disclosure of which is incorporated herein by reference in its entirety. The circuitry and/or instructions stored in the hot shoe mountable wireless device can provide a signal to the camera through the hot shoe for one information cycle that instructs the camera that makes the device sitting in the hot shoe look like a flash device in a manual flash operating mode. The camera transmits data that includes a value for ISO without the FC value combined therein. The wireless device can then send appropriate signals to the camera through the hot shoe the makes the device in the hot shoe appear to the camera as a flash device operating in a TTL mode. The camera then transmits the combined ISO and FC value. The FC value can be determined from the ISO value and the combined ISO and FC value. In one example, such a procedure is utilized in a method and/or system of direct power control as discussed above. In another example, such a procedure is utilized in a method and/or system of automatic power tracking control as discussed above.

In still another implementation, a method of automatic power control and calibration is provided. A remote lighting device is set to a first power output level. An associated camera device having an EC/FC control is set to an EC/FC value of a starting value (e.g., zero). A picture is taken. A determination of appropriateness is made. The EC/FC value is modified to a new value, the change in the EC/FC value is used to track a change in f-stop value associated with the EC/FC change and correlate a relative change for the power output level of the lighting device. The new output level is set (e.g., via wireless communication). Another picture is taken, a half press is activated, and/or other camera and/or wireless device control is actuated. The EC/FC value is reset automatically to the starting value (e.g., via an external wireless device communicating a forced value for EC/FC back through the hot shoe). The process can repeat for further adjustment up and down to the lighting device power output without need for an initial mapping or metering data (e.g., from the lighting device or TTL metering).

In a camera where another default value for EC/FC exists other than zero, such a value can be used as a starting point in place of zero.

In a yet another implementation, a method of controlling the light power output of a photographic lighting device operating in a non-automated light power mode with a camera having a manual exposure compensation adjustment having a compensation range settable at compensation increments, the photographic lighting device having a light power output range settable at power output increments from a minimum power output level to a maximum power output level, is provided. The method includes mapping a starting power output increment of a photographic lighting device to a starting compensation increment of a camera. The exposure compensation adjustment of the camera is adjusted to a second compensation increment. A power adjustment to the light power output of the photographic lighting device is determined based on the second compensation increment. In this implementation the photographic lighting device operates in a non-automated light power mode. The power output of the photographic lighting device is adjusted using the power adjustment.

FIG. 9 illustrates one exemplary implementation of a system 900 for directly controlling power output of a lighting device using an EC/FC control of a camera body. System 900 includes an EC/FC value input 905. EC/FC input 905 is electrically connected to a processor 910. A user can input an EC/FC value into input 905 of a camera. Processor 910 controls the input of the data and may utilize a memory 915 to store a current EC/FC setting, information related to an EC/FC range, information related to one or more correlations between an EC/FC setting increment of the camera and a power output setting increment of a lighting device, and/or other information. Processor 910 correlates the current EC/FC setting value to a corresponding power output setting of a lighting device using information stored in memory 915. Processor 910 communicates the corresponding power output setting to a power control input 920 to the lighting device.

The components of system 900 are shown as separate single components. It is contemplated that any one or more functionalities of a single component may be implemented by two or more components. For example, the functionalities of processor 910 may be provided by two separate processors (e.g., one processor to manage current EC/FC settings, another processor to correlate power output settings).

FIG. 23 illustrates multiple views of a photographic wireless communication device 2305. Wireless communication device 2305 includes an internal transmitter component (not shown) for wirelessly transmitting power control information to one or more remote devices and an internal antenna component (not shown). Wireless communication device may include appropriate circuitry and instructions for execution by one or more processing elements for implementing one or more of the aspects of implementations and embodiments of methods for direct power control and/or automatic tracking of power output levels with ISO and/or aperture, as disclosed herein. In one example, wireless communication device 2305 includes circuitry similar to system 900 for directly controlling power output of a lighting device using an EC/FC control of a camera body and automatically tracking power output as described herein. Wireless communication device 2305 includes a first hot shoe connector 2310 configured to connect to a hot shoe connector of a camera and provide electrical communication with the circuitry and/or electronics of the camera (e.g., communication with data, clock, and/or X-synch signals). Wireless communication device 2305 also includes a second hot shoe connector 2315 configured to allow another device having a hot shoe connector to be connected to the top of wireless communication device 2305. In one example, a speedlight flash device may be connected to hot shoe connector 2315. Wireless communication device 2305 also includes a tightening ring 2320 for securely connecting hot shoe connector 2310 to a corresponding hot shoe of a camera.

Wireless communication device 2305 includes a USB data connector 2325 for inputting and outputting information from wireless communication device 2305 and the early synchronization functionality therein. An input 2330 and an input 2335 provide information input and control to wireless communication device 2305. Input 2330 includes a selector switch for selecting one or a plurality of operating modes. In one example, mode C1 of the switch can be used to select a first operating mode for the device (e.g., an operating mode for a first lighting zone having a first power output setting via an EC/FC camera control) and mode C2 of the switch can be used to select a second operating mode for the device (e.g., an operating mode for a second lighting zone having a second power output setting via an EC/FC camera control). Device 2305 can be configured to preserve settings from one mode to another so that when the mode switch is returned to a mode, the prior settings are reset from a memory. Wireless communication device 2305 includes an optical output element 2340 for outputting information.

A camera utilized in any one or more of the above embodiments and/or methodologies may operate in any mode. In one example, a camera may operate in an aperture priority mode during a power control operation as described herein. In another example, a camera may operate in a shutter priority mode during a power control operation as described herein. In yet another example, a camera may operate in a program mode during a power control operation as described herein. In still another example, a camera may operate in a manual mode during a power control operation as described herein. In one such example, a camera may not normally utilize an EC value when the camera is in a manual mode.

A lighting device utilized in any one or more of the above embodiments and/or methodologies may be any type of photographic lighting device. Where a speedlight has been utilized for above, it may be replaced by one or more lighting devices of the same type and/or a different type. A lighting device utilized in any one or more of the above embodiments and/or methodologies may operate in any mode. In one example, a lighting device may operate in an automated mode (e.g., TTL, AUTO). In another example, a lighting device may operate in a manual mode. In one exemplary aspect of one or more of the embodiments and/or methodologies described herein may include the ability to automate the control of the power output of a lighting device (e.g., via a direct control using an EC/FC control, via an automated tracking) operating in a manual mode.

The various implementations and embodiments disclosed herein for direct control and/or automatic tracking of a power output level of a lighting device may allow a lighting device that could not previously take advantage of direct power control from a camera body to perform direct power control. In another example, the implementation and embodiments allow lighting devices that could not automate power output tracking with ISO and/or aperture changes to do so. In one example, such a lighting device is a voltage controlled light emission power output lighting device. Voltage controlled light emission power output lighting devices may require to much time to make power adjustments at or near image acquisition. Power control according to the current disclosure allows power adjustments at a time disconnected from image acquisition and metering through the lens. In another example, such a lighting device is set to operate in a non-TTL mode. In yet another example, such a lighting device is set to a non-fully-automated mode.

Power control data values that are wirelessly transmitted to a remote lighting device may take a variety of forms. In one example, a power control data value wirelessly transmitted may be an adjustment to a previous value. In one such example, a local wireless device at the flash side may keep track of the last value. A local wireless device at the camera side may keep track of last value for adjustment. In one such example, a conversion of the adjustment value to an absolute power value occurs prior to wireless transmission. In another example, a power control data value wirelessly transmitted may be an absolute power output value.

Changes from one power output setting to another (e.g., when a change is made to an EC/FC setting value, when a change is made to aperture and/or ISO) may be made at any time. In one example, a change in a power output setting occurs upon actuation of a control at the camera (e.g., half press trigger, another control). In another example, a change in a power output setting occurs at intervals in time. Other variations are contemplated.

Power control data (e.g., power output adjustments and/or absolute power output settings) that are sent to a remote lighting device may be communicated to the remote lighting device in a variety of ways. In one example, a wireless communication device is internal to the lighting device. In another example, a wireless communication device is externally connected to the lighting device (e.g., through a power output control).

EC/FC values, adjustments, and other calibration and/or use interaction related to power control as described herein may occur via an input control and/or an output device. In one example, a configuration utility may run on a computing device connected (wiredly and/or wirelessly) to the camera, wireless communication device, and/or lighting device. The configuration utility may provide tools for setting values related to power control as described herein.

In one alternative example, EC/FC controls may be part of (or an adjunct accessory to) an external wireless communications device. In one such example, a set of EC/FC controls may be mounted in an upper hot shoe connector of a wireless communications device, such as the device of FIG. 23. The EC/FC controls may be utilized as the EC/FC controls of a camera are utilized throughout this disclosure.

Exemplary embodiments have been disclosed above and illustrated in the accompanying drawings. It will be understood by those skilled in the art that various changes, omissions and additions may be made to that which is specifically disclosed herein without departing from the

It is to be noted that the aspects and embodiments described herein may be conveniently implemented using one or more circuit elements as described above and/or included in one or more of a camera, a wireless communication device, and a lighting device programmed according to the teachings of the present specification. Appropriate software coding for combination with appropriate circuitry and other electronic components can readily be prepared by skilled programmers based on the teachings of the present disclosure, as will be apparent to those of ordinary skill in the software art.

Such software may be a computer program product that employs a machine-readable medium. A machine-readable medium may be any medium that is capable of storing and/or encoding a sequence of instructions for execution by a machine (e.g., a processor and other electrical components of a camera, a wireless communication device, a flash device) and that causes the machine to perform any one of the methodologies and/or embodiments described herein. Examples of a machine-readable medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as the possibility of including a collection of physically separate media, such as, for example, a collection of compact disks.

1. A method of controlling a power output level of a photographic lighting device with a photographic exposure compensation control of a camera, the photographic lighting device being set to a first power output level and the photographic exposure compensation control being set to a first compensation value, the method comprising:
changing the photographic exposure compensation control to a second compensation value;
using the second compensation value and a mapping of the dynamic range of a photographic exposure compensation control of a camera to the dynamic range of a power output level of a photographic lighting device, determining a second power output level that corresponds to the second compensation value; and
automatically setting the photographic lighting device to the second power output level.

2. A method according to claim 1, wherein the camera is set to a first ISO and aperture setting combination and the second power output level is a desired power output level for the first ISO and aperture setting combination, the method further comprising:
adjusting the ISO setting and/or the aperture setting of the camera;
automatically determining an updated power output level based on the adjusted ISO and/or aperture settings and the mapping; and
automatically setting the photographic lighting device to the updated power output level.

3. A method according to claim 1, wherein the camera is set to a first ISO and aperture setting combination, the method further comprising:
determining a desired power output level for the photographic lighting device for the first ISO setting and the first aperture setting;
setting the photographic lighting device to the desired power output level;
adjusting the ISO setting and/or the aperture setting of the camera;
automatically determining an updated power output level; and
automatically setting the photographic lighting device to the updated power output level.

4. A method according to claim 3, wherein said determining a desired power output level includes:
changing the photographic exposure compensation control to a third compensation value;
using the mapping and the third compensation value, determining a third power output level that corresponds to the third compensation value; and
automatically setting the photographic lighting device to the second power output level.

5. A method according to claim 1, wherein said automatically setting the photographic lighting device is performed wirelessly.

6. A method according to claim 1, wherein said automatically setting the photographic lighting device includes controlling a capacitor voltage of a voltage controlled light emission power output lighting device.

7. A method according to claim 1, wherein the photographic lighting device is a voltage controlled light emission power output lighting device.

8. A method according to claim 1, wherein the photographic lighting device is set to operate in a non-TTL mode.

9. A method according to claim 1, wherein the photographic lighting device is set to a nonfully-automated mode.

10. A method according to claim 1, wherein the photographic exposure compensation control includes a camera exposure control and the camera is set to a manual or aperture priority mode.

11. A method according to claim 1, wherein the photographic exposure compensation control is a camera exposure compensation control.

12. A method according to claim 1, wherein the photographic exposure compensation control is a flash compensation control.

13. A method according to claim 1, wherein the photographic lighting device is set to a mode that is intended to require human interaction to change the power output level.

14. A method according to claim 1, wherein the photographic lighting device has the ability to adjust the illumination output level of the lighting device prior to triggering a flash burst.

15. A method of controlling a power output level of a photographic lighting device, the method comprising:
generating a mapping of the dynamic range of a photographic exposure compensation control of a camera to the dynamic range of a power output level of a photographic lighting device;
providing, after said mapping, the lighting device with the power output level set to a first power output level;
providing, after said mapping, the camera with the photographic exposure compensation control set to a first compensation value;
changing the photographic exposure compensation control to a second compensation value;
using the mapping and the second compensation value, determining a second power output level that corresponds to the second compensation value; and
setting the photographic lighting device to the second power output level.

16. A wireless photographic communication device for synchronizing a camera to a photographic lighting device, the wireless photographic communication device comprising:
a connection to an external connector of the camera that provides a signal including a value for a current photographic exposure compensation value of the camera;
a memory including information having a mapping of the dynamic range of a photographic exposure compensation control of the camera to a dynamic range of a power output level of the photographic lighting device;
a transmitter; and
a processor for correlating the current photographic exposure compensation value to a power output level of the lighting device and using the transmitter to wirelessly communicate the power output level of the lighting device to the lighting device.

17. A system of controlling a power output level of a photographic lighting device with a photographic exposure compensation control of a camera, the photographic lighting device being set to a first power output level and the photographic exposure compensation control being set to a first compensation value, the system comprising:
a means for changing the photographic exposure compensation control to a second compensation value;
a means for using the second compensation value and a mapping of the dynamic range of a photographic exposure compensation control of a camera to the dynamic range of a power output level of a photographic lighting device, determining a second power output level that corresponds to the second compensation value; and
a means for automatically setting the photographic lighting device to the second power output level.

18. A system according to claim 17, wherein the camera is set to a first ISO and aperture setting combination and the second power output level is a desired power output level for the first ISO and aperture setting combination, the system further comprising:
a means for adjusting the ISO setting and/or the aperture setting of the camera;
a means for automatically determining an updated power output level based on the adjusted ISO and/or aperture settings and the mapping; and
a means for automatically setting the photographic lighting device to the updated power output level.

19. A system according to claim 17, wherein the camera is set to a first ISO and aperture setting combination, the system further comprising:
a means for determining a desired power output level for the photographic lighting device for the first ISO setting and the first aperture setting;
a means for setting the photographic lighting device to the desired power output level;
a means for adjusting the ISO setting and/or the aperture setting of the camera;
a means for automatically determining an updated power output level; and
a means for automatically setting the photographic lighting device to the updated power output level.

20. A system according to claim 17, wherein said determining a desired power output level includes:
a means for changing the photographic exposure compensation control to a third compensation value;
a means for using the mapping and the third compensation value, determining a third power output level that corresponds to the third compensation value; and
a means for automatically setting the photographic lighting device to the second power output level.

21. A system according to claim 17, wherein said means for automatically setting the photographic lighting device is performed wirelessly.

22. A system according to claim 17, wherein said means for automatically setting the photographic lighting device includes controlling a capacitor voltage of a voltage controlled light emission power output lighting device.

23. A system according to claim 17, wherein the photographic lighting device is a voltage controlled light emission power output lighting device.

24. A system according to claim 17, wherein the photographic lighting device is set to operate in a non-TTL mode.

25. A system according to claim 17, wherein the photographic lighting device is set to a nonfully-automated mode.

26. A system according to claim 17, wherein the photographic exposure compensation control includes a camera exposure control and the camera is set to a manual or aperture priority mode.

27. A system according to claim 17, wherein the photographic exposure compensation control is a camera exposure compensation control.

28. A system according to claim 17, wherein the photographic exposure compensation control is a flash compensation control.

29. A system according to claim 17, wherein the photographic lighting device is set to a mode that is intended to require human interaction to change the power output level.

30. A system according to claim 17, wherein the photographic lighting device has the ability to adjust the illumination output level of the lighting device prior to triggering a flash burst.

31. A method of controlling a power output level of a photographic lighting device with a photographic exposure compensation control of a camera set to a first ISO setting and a first aperture setting, the method comprising:
determining a desired power output level for the photographic lighting device for the first ISO setting and the first aperture setting;
setting the photographic lighting device to the desired power output level;
adjusting the ISO setting and/or the aperture setting of the camera;
automatically determining an updated power output level; and
automatically setting the photographic lighting device to the updated power output level.

32. A method of wirelessly controlling a power level of a non-TTL capable photographic flash device having the ability to adjust the illumination output level prior to triggering a flash burst by a camera, the method comprising:
detecting an exposure compensation signal generated by manual input by a user actuating a control of a camera body operating in a mode that does not automatically adjust the aperture utilized for image acquisition based on the exposure compensation inputs of the camera body;
wirelessly communicating an instruction based on the exposure compensation signal to a remote non-TTL flash device;
automatically adjusting the amount of stored energy for flash illumination in the non-TTL flash device based on the instruction prior to initiation of a flash emission by the non-TTL flash device.

33. A method of wirelessly controlling a power level of a non-TTL capable photographic flash device having the ability to adjust the illumination output level prior to triggering a flash burst by a camera, the method comprising:
detecting an exposure compensation signal generated by manual input by a user actuating a control of a camera body operating in a mode that does not automatically adjust the aperture utilized for image acquisition based on the exposure compensation inputs of the camera body;
wirelessly triggering the emission of a remote non-TTL flash device to correspond with a first image acquisition by the camera body;
detecting an aperture setting and a gain setting of the camera body, wherein the aperture and/or gain setting is different from the corresponding setting of the camera body used for the first image acquisition;
wirelessly adjusting the power output capability of the non-TTL flash device prior to flash light emission of the non-TTL flash device based on a calculated power adjustment, the power adjustment calculated from the exposure compensation signal, the aperture setting, and the gain setting; and
wirelessly triggering the emission of the remote non-TTL flash device to correspond with a second image acquisition by the camera body.
